(19) United States
(12) Patent Application Publication
(10) Pub. No.: US 2003/0117229 A1
(43) Pub. Date: Jun. 26, 2003

(54) Low loss tuners

(76) Inventor: Stephen K. Remillard, Evanston, IL (US)

Correspondence Address: MARSHALL, GERSTEIN & BORUN, 6300 SEARS TOWER, 233 SOUTH WACKER, CHICAGO, IL, 60606-6357, US

(21) Appl. No.: 10/027,078

(22) Filed: Dec. 20, 2001

(51) Int. Cl. H01P 1/20; H01B 12/02

(52) U.S. Cl. 333/99 S; 333/202; 333/219; 505/210

(57) ABSTRACT

Low loss tuners including a conductive tuning element and an electrical insulator may be used in conjunction with superconducting or any other resonant elements that form couplerions of RF filters. The low loss tuners prevent currents induced on the conductive tuning element from shorting to ground and causing heating and Q degradation in the RF filter.

### TECHNICAL FIELD

The present invention is directed generally to tuners and, more particularly, to low loss tuners that may be used to tune frequencies at which resonant elements resonate.

### BACKGROUND

The use of dielectric resonators in radio frequency (RF) filters is known. Dielectric resonators include dielectric resonant elements disposed within a grounded conductive cavity, wherein the dielectric elements each resonate at a particular frequency. The frequency at which the dielectric elements resonate determines the frequency characteristics (e.g., the passband, etc.) of the RF filters in which the dielectric resonators are used.

The frequency at which a dielectric resonator of an RF filter resonates may be tuned, or altered, through the introduction of a tuning element into the conductive cavity and into proximity with the dielectric element. It is commonly known to use a conductive screw threaded through a wall of the grounded cavity to tune or detune the resonant frequencies of the dielectric resonators. Detuning may consist of altering, or reducing, the resonant frequency of a dielectric resonator. When the conductive screw is proximate a dielectric element, the screw perturbs the fields of the element and changes the frequency at which the resonator resonates. In this manner, an RF filter composed of numerous cavities, each of which holds a dielectric resonant element, may be frequency tuned, thereby changing the passband and other characteristics of the RF filter.

The introduction of a screw into the cavity of a dielectric resonator induces currents on the screw that are shunted to ground causing losses and creating a degradation in the quality factor (Q) of the filter. Although not desirable, this Q degradation is not generally considered unacceptable in dielectric resonator RF filters because such filters typically have Q's in the range of 10,000 to 20,000, which, although affected by the tuning screw losses, are not significantly degraded. For example, the Q of a dielectric resonator RF filter may degrade from 10,000 to 20,000 to 9,000 to 17,000 after the introduction of a tuning screw. Accordingly, it is generally considered acceptable to trade Q for tunability of a dielectric resonator using a screw tuner.

The advent of superconducting technology and the use of this technology in the construction of superconducting resonant elements, as opposed, or in addition to, dielectric resonant elements used in RF filters has yielded superconducting RF filters having Q's on the order of 50,000. While the Q degradation associated with tuning screws in a dielectric resonator RF filter is not desirable, but generally considered tolerable, the same cannot be said for the Q degradation associated with tuning superconducting filters, because one of the advantages that superconducting filters offer over dielectric-based filters is enhanced Q. While an untuned superconducting filter may have a Q on the order of 50,000 when not detuned (i.e., when the filters do not have their resonant frequencies reduced), the Q of the same filter could degrade to roughly 41,000 when tuning screws are introduced into the cavities of the filter to detune the frequency of the resonators by 5 megahertz (MHz). Additionally, while operating at high RF power such as, for example, 10 watts, the losses associated with currents induced on the tuning screws and shunted to ground generate heat, which impacts the controlled, cooled environment in which superconducting RF filters must operate.

Even though the Q degradation associated with the use of tuning screws may dramatically affect the performance of an RF filter, RF filters (both superconducting and non-superconducting), nevertheless, need to be tuned during manufacturing processes. This tuning is commonly performed using conductive screws. Accordingly, the Q degradation associated with tuning screws in RF filters has been viewed as a necessary evil.

### SUMMARY

According to a first aspect, a tuning mechanism for use in a filter including cavity having a plurality of walls and a resonator disposed within the cavity is disclosed. Such a tuning mechanism may include a conductive tuning element adapted to be inserted into the cavity in a location proximate to the resonator, thereby perturbing an electric field of the resonator. The tuning element may also include an electrical insulator mounted to the conductive tuning element and adapted to be adjustably mounted to one of the plurality of walls to hold the conductive tuning element in the location proximate to the resonator.

According to a second aspect, the tuning mechanism may include a conductive tuning element adapted to be inserted into the cavity in a location proximate to the resonator and an electrical insulator coupled to the conductive tuning element to hold the conductive tuning element in the location proximate to the resonator. In such an arrangement, the tuning mechanism may further include an adjustment element mounted to the electrical insulator and adapted to be adjustably mounted with respect to one of the plurality of walls to hold the conductive tuning element in the location proximate to the resonator.

According to a third aspect, a tuning mechanism for use in a superconducting filter including cavity having a plurality of walls and a superconducting resonator disposed within the cavity is disclosed. In such an application, the tuning mechanism may include a conductive tuning element having first and second ends and adapted to be inserted into the cavity in a location proximate to the superconducting resonator and an electrical insulator having first and second ends, wherein the first end of the electrical insulator is threaded into the second end of the conductive tuning element to hold the conductive tuning element in the location proximate to the superconducting resonator. The tuning mechanism may further include a substantially cylindrically shaped adjustment element having first and second ends, wherein the second end of the electrical insulator is threaded into the first end of the adjustment element and the adjustment element is adapted to be threaded into one of the plurality of walls to hold the conductive tuning element in the location proximate to the superconducting resonator.

The features and advantages of the present invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is an exemplary isometric view of a radio frequency (RF) filter;

FIG. 2 is a detailed view of a couplerion of the RF filter of FIG. 1;

FIG. 3 is a cross-sectional view of the RF filter of FIG. 2 taken along lines 3-3;

FIG. 4 is a detailed view of the adjustable tuner of FIGS. 1-3;

FIG. 5 is a cross-sectional view of the adjustable tuner of FIG. 4 taken along lines 5-5;

FIG. 6 is an exemplary detailed view of an alternate embodiment of an adjustable tuner;

FIG. 7 is a cross-sectional view of the adjustable tuner of FIG. 6 taken along lines 7-7; and

FIG. 8 is an exemplary graph illustrating the Q performance of a filter when that filter is tuned with a low loss tuner and when that filter is tuned with a conventional tuner.

### DETAILED DESCRIPTION

Low loss tuners, various exemplary embodiments of which are described hereinafter in detail, may be used in conjunction with resonant elements used in RF filters, which may be constructed using either or both superconducting and non-superconducting technologies. The following illustrative description includes detail on both exemplary superconductive RF filters in which low loss tuners may be used, as well as detail on exemplary low loss tuners themselves. As will be readily appreciated by those having ordinary skill in the art, the low loss tuners described herein may readily be used in conjunction with non-superconducting filters.

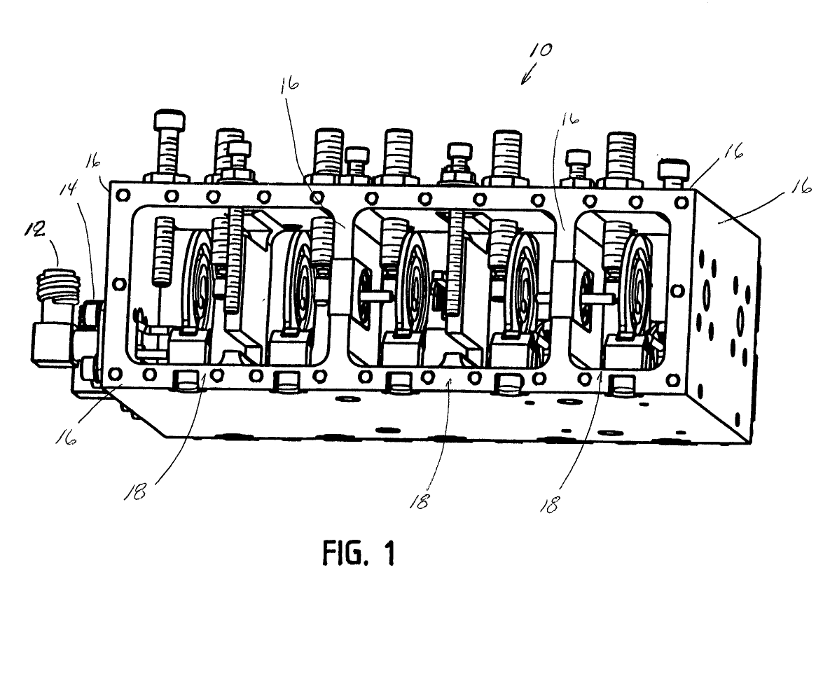

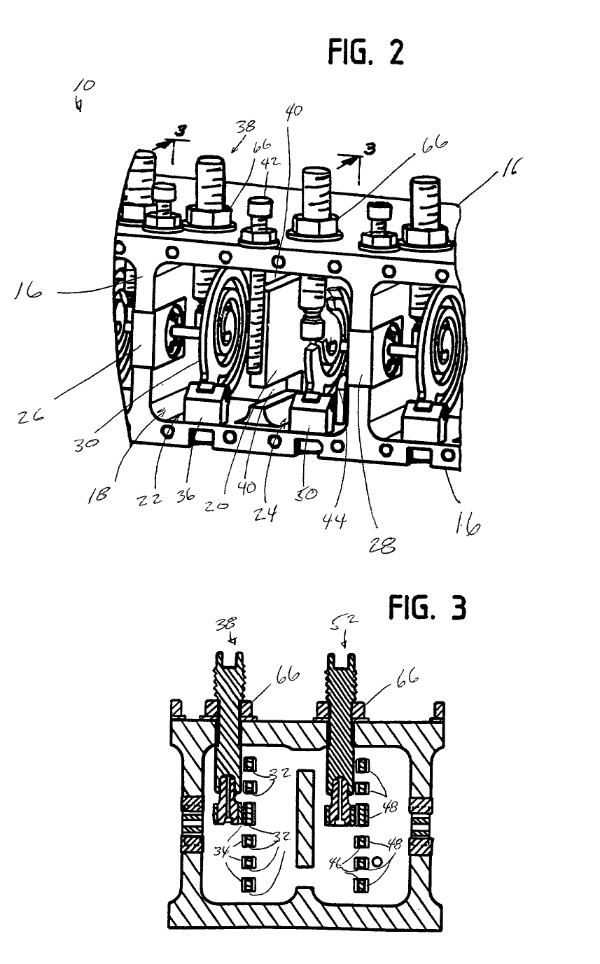

Referring now to FIG. 1, an exemplary radio frequency (RF) filter 10 includes an input 12, an output 14 and a housing comprising a number of walls, each of which is referred to using reference numeral 16, and a cover (not shown). The walls 16 form cavities, which are generally referred to at reference numeral 18. Details regarding the components of one such cavity 18 are discussed below in conjunction with FIGS. 2 and 3. In practice, the walls 16 and the cover may be fabricated from a conductive material such as aluminum, copper or any suitable material and may or may not be plated. Alternatively, the walls 16 and the cover may be fabricated from a non-conductive material and may be plated, or otherwise coated, with a conductive material.

Turning now to FIGS. 2 and 3, one cavity 18 of the RF filter 10 includes a septum 20 that divides the cavity 18 into smaller first and second cavities 22, 24. The septum 20 may be fabricated integrally with the walls 16 and may be fabricated from the same material as the walls 16. Alternatively, the septum 20 could be fabricated separately from the walls 16 and could be fastened thereto using any suitable technique.

First and second input/output couplers 26, 28 are provided in the walls 16 to couple electromagnetic energy into and out of the cavity 18. As will be readily appreciated by those having ordinary skill in the art, the first and second input/output couplers 26, 28 may couple electric fields or magnetic fields and, therefore, may take different configurations than those shown in the drawings. For example, a coupler may be fabricated as an aperture having an antenna disposed therein if electric fields are to be coupled. Alternatively, a coupler may be fabricated as a window if magnetic fields are to be coupled. It should also be noted that any suitable combination of couplers (i.e., electric or magnetic couplers) may be used to couple energy to and from the cavity 18 of the RF filter 10.

Turning now the components disposed within the first cavity 22, a first superconducting resonator 30 includes a first substrate 32 and a first superconductive coating 34 disposed on the first substrate 32. The first substrate 32 may be yttria stabilized zirconia (YSZ) or any other suitable substrate. Alternatively, the first substrate 32 need not be ceramic, but may be stainless steel 304, Pyromet® 600, which is commercially available from Carpenter Steel Company, or any other suitable material. The first substrate 32 may be fabricated as a slotted spiral, as shown in the drawings, or may be fabricated in any other suitable physical shape, such as, for example, quarter-wave rods, half-wave rods, toroids or rings.

The first superconductive coating 34 may be a thick film, high temperature superconductive (HTS) coating such as YBa₂Cu₃O_{7-δ} (YBCO), Bi₂Sr₂CaCu₂Oₓ (BSCCO), Tl₂Ba₂CaCu₂Oₓ (TBCCO), any one the materials commonly referred to generally as cuprates or any other suitable superconductive coating. The first superconductive coating 34 may be deposited on the first substrate 32 via sputtering, dipping, inking, painting or any other suitable manner. Further detail regarding the deposition of HTS thick film coatings on substrates may found in commonly-owned U.S. patent application Ser. No. 09/799,782, which was filed on Mar. 6, 2001, and is expressly incorporated herein by reference.

After the first superconductive coating 34 is deposited on the first substrate 32, the first superconducting resonator 30 may be fired, or sintered, to fix the first superconductive coating 34 to the first substrate 32. The first superconducting resonator 30 may be fastened to one of the walls 16 of the RF filter 10 using a first mount 36. Further detail regarding the fabrication and materials that may be used in fabricating both the substrate and the superconductive “coating” of the first superconducting resonator 30 may be found in commonly-owned U.S. patent application Ser. No. 09/891,747, which was filed on Jun. 26, 2001, and is expressly incorporated herein by reference.

Returning to the description of the components in the first cavity 22, a first adjustable tuner 38, or tuning mechanism, which is described below in detail in conjunction with FIGS. 3-5 may be adjustably inserted into the first cavity 22 via a first threaded through hole (not shown) disposed in one of the walls 16 of the cavity 18 of the RF filter 10. As is discussed in further detail below, the first adjustable tuner 38 disturbs the electromagnetic fields surrounding the first superconducting resonator 30, thereby detuning or changing the frequency at which the first superconducting resonator 30 resonates. Advantageously, however, the first adjustable tuner 38, due to its configuration, does not shunt currents that are induced thereon to ground, thereby eliminating Q degradation and heating associated with conventional, grounded, conductive screw tuners. The tuner construction disclosed in conjunction with the first adjustable tuner 38 may be used in conjunction with either superconducting or non-superconducting resonators.

As noted previously, the first and second cavities 22, 24 are separated by the septum 20 and apertures 40 are provided on either side of the septum 20 for coupling electromagnetic energy therebetween. A coupling adjustor 42 may be inserted through a hole in the wall 16 and into or near one of the apertures 40 to adjust the coupling between the first and second cavities 22, 24. As will be readily appreciated by those having ordinary skill in the art, the coupling adjustor 42 may be fabricated from a screw or any other suitable element capable of being positioned within the apertures 40. Alternatively, or additionally, the coupling adjustor 42 may be fabricated in a manner similar or identical to the first adjustable tuner 38 to increase the range of coupling adjustment between the first and second cavities without drastically affecting the Q of the RF filter 10.

Turning now to the description of the second cavity 24, a second superconducting resonator 44 (shown partially removed) including a second substrate 46 and a second superconductive coating 48 is fixed via a second mount 50 to one of the walls 16 of the second cavity 24 of the RF filter 10. Also disposed within the second cavity 24 is a second adjustable tuner 52 that is inserted through a second threaded through hole in the wall 16. The second adjustable tuner 52 perturbs electromagnetic fields about the second superconducting resonator 44 to alter, or detune, the frequency at which the second superconducting resonator 44 resonates.

The elements discussed in conjunction with the second cavity 24 may be fabricated in a manner that is similar or identical to the corresponding elements described in conjunction with the first cavity 22. Additionally, the material and fabrication differences and substitutions described in conjunction with the first cavity 16 also apply to the corresponding elements of the second cavity 24.

While the foregoing description of the first and second superconducting resonators 30, 44 may be generically referred to as thick film superconductor technology, it should be noted that the fabrication of the first and second superconducting resonators 30, 44 is not be limited to thick film technology. In fact, the first and second superconducting resonators 30, 44 could conceivably be fabricated from “thin film” superconductor technology such as YBCO, BSCCO or TBCCO. Further detail regarding thin film superconductor technology its uses and its fabrication may be found in U.S. Pat. No. 6,122,533, which is commonly-owned and is expressly incorporated herein by reference.

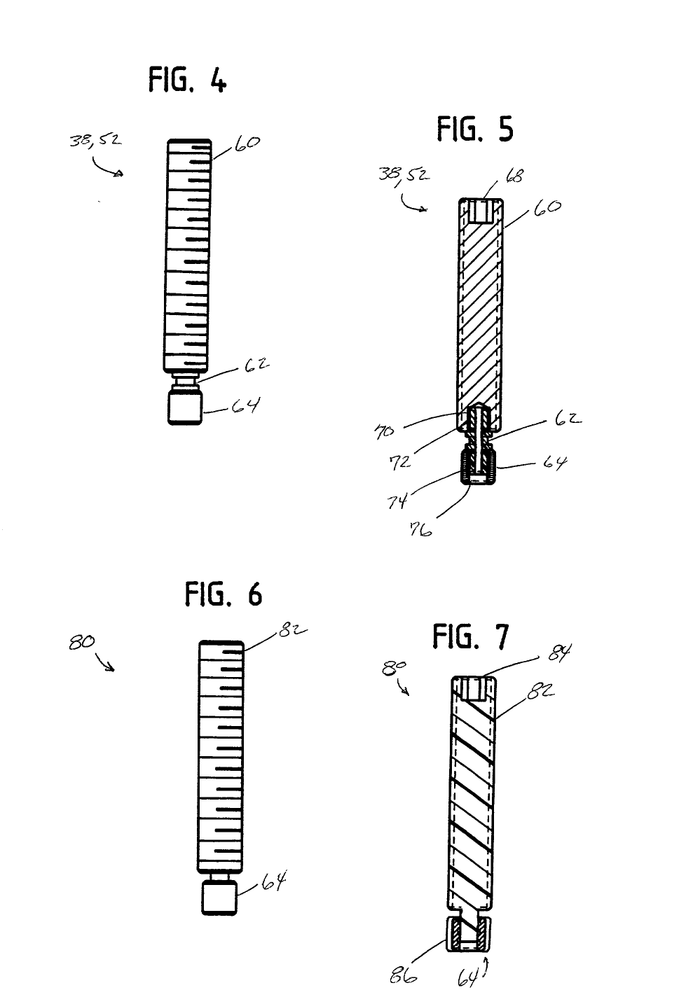

Turning now to FIGS. 4 and 5, further detail regarding the first and second adjustable tuners 38, 52 is provided. Generally, the first and second adjustable tuners 38, 52 each include an adjustment element 60, an electrical insulator 62 and a conductive tuning element 64. In operation, when the tuning element 64 perturbs the fields of the resonator, the currents induced on the tuning element 64 are not shorted to the grounded walls 16, owing to the insulator 62 disposed between the adjustment element 60 and the tuning element 64. Advantageously, the attendant heating and Q degradation associated with shunting the induced tuner currents to ground are avoided.

The adjustment element 60, which may be fabricated from brass, stainless steel, copper, aluminum, plastic or any other suitable material, is sized and threaded to engage the threaded through holes in the wall 16 to make an electrical connection therewith. The pitch of the threads on the adjustment element 60 may be from 32-128 threads per inch and the diameter of the adjustment element 60 may be similar to that of a number eight screw or may have any suitable diameter that may be the same, smaller or slightly larger than the diameter of the tuning element 64. The adjustment element 60 may have a length between approximately 0.75 and 1 inch or may be of any other suitable length.

Alternatively, the through holes and the adjustment element 60 may not be threaded and may slidably or otherwise engage one another, thereby allowing adjustability of the position of the adjustment element 60 without the use of threads. Additionally, a threaded collar (not shown) could be fixed to an outside surface of the wall 16 over a through hole so that the adjustment element 60 could engage the threaded collar and the adjustment element 60 would not need to be threaded or engage the wall 16 in any manner. Alternatively, a threaded or unthreaded bushing may be inserted into the wall 16 so that the adjustment element 60 could be threaded into the bushing and not threaded directly into the wall 16. Additionally, it should be noted that the adjustment element 60 may be capable of being rendered non-adjustable using glues, such as Loctite®, or mechanical elements, such as set screws or locknuts 66, once the desired setting of the conductive tuning element 64 is achieved. Accordingly, although the drawings show that the adjustment element 60 is threaded, such a disclosure is merely exemplary and should not, therefore, be considered as limiting.

The insulator 62 may be 0.125 inches in length and may be fabricated from a plastic or any other suitable dielectric material such as Ultem® 1000, which is commercially available from General Electric Corporation. Alternatively, the insulator 62 may be fabricated from any other suitable material, such as resin, ceramic or any other non-conducting material. Examples of such materials may include, for example, nylon, Rexolite®, and G-10, which is a fiber-loaded resin.

The tuning element 64 may be cylindrically shaped and may be fabricated from a superconducting or non-superconducting material that may be metallic or otherwise conductive and may have a length and a diameter of approximately 0.125 inches. In particular, the tuning element 64 may be fabricated from copper, unplated or silver plated aluminum, silver plated stainless steel, a silver plated nickel alloy such as Pyromet® or any other suitable material. Additionally, the tuning element could be gold plated Ultem® 1000. While the tuning element 64 is shown as being cylindrically-shaped in the drawings, those having ordinary skill in the relevant art will readily appreciate that the tuning element 64 could have any suitable shape other than that of a cylinder and, therefore, the cylindrical shape of the tuning element 64 is merely exemplary. For example, the tuning element 64 may be spherically shaped.

As shown in FIG. 5, the adjustment element 60 includes an adjustment tool receptacle 68, which may be a slot to receive a flat blade screwdriver, a recessed cross to receive a Phillips head screwdriver or a hexagonal detail to receive an Allen wrench. The use of an adjustment tool enables turning of the adjustment element 60 with respect to the wall 16 and thereby moves the tuning element 64 with respect to the first or second superconducting resonant elements 30, 44.

The end of the adjustment element 60 opposite the adjustment tool receptacle 68 includes a threaded bore 70 that is adapted to receive a first threaded shaft 72 that is part of the insulator 62. The insulator 62 also includes a second threaded shaft 74 opposite the first threaded shaft 72. The first and second threaded shafts 72, 74 may be of, for example, a number two size and may have, for example, 56 threads per inch. The second threaded shaft 74 is installed into a threaded through hole 76 within the tuning element 64.

Although the insulator 62 is shown as being threaded into the adjustment element 60 and the tuning element 64, it should be noted these two elements may be coupled in any other suitable manner. For example, the adjustment element 60, the insulator 62 and the tuning element 64 may be glued together or may be coupled using any other suitable technique. Alternatively, the tuning element 64 could be plated directly onto the insulator 62, thereby connecting the tuning element 64 to the insulator 62.

An alternate adjustable tuner 80, as shown in FIGS. 6 and 7, eliminates the adjustment element 60 in favor of an insulative adjustment element 82 that may be fabricated from the same materials used to fabricate the insulator 62 of FIGS. 4 and 5. The insulative adjustment element 82 may include an adjustment tool receptacle 84 that, in a similar manner to that described in conjunction with the adjustment tool receptacle 68 of FIG. 5, accommodates a tool that may be used to turn the alternate adjustable tuner 80 with respect to the wall 16 of RF filter 10. The insulative adjustment element 82 may further include a threaded shaft 85 that may be threaded into the through hole 76 of the tuning element 64. As with the embodiment shown in FIGS. 4 and 5, the tuning element 64 could be glued, plated or otherwise fixed to the insulative adjustment element.

As with the adjustment element 60, the insulative adjustment element 82 and the through holes in the RF filter 10 need not be threaded and may slidably or otherwise engage one another, thereby allowing adjustability of the position of the adjustment element 60. Accordingly, although the drawings show that the insulative adjustment element 82 is threaded, such a disclosure is merely exemplary and should not, therefore, be considered to be limiting. Additionally, the insulative adjustment element 82 may be fixed with respect to the wall 16 using material such as, for example, Loctite® or any other suitable material, or using a locknut 66, a set screw or any other mechanical element, once the proper adjustment position for the alternate adjustable tuner 80 is found.

Also shown in FIG. 7 is a superconductive coating 86 that may be disposed on the tuning element 64 to further reduce Q degradation and allow even more detuning of a resonator without significant Q degradation. Although the superconductive coating 86 is shown only on the tuning element 64 coupled to the insulative adjustment element 82, this is merely exemplary and it is contemplated that the superconductive coating 86 could be applied to any tuning element 64 shown in the drawings.

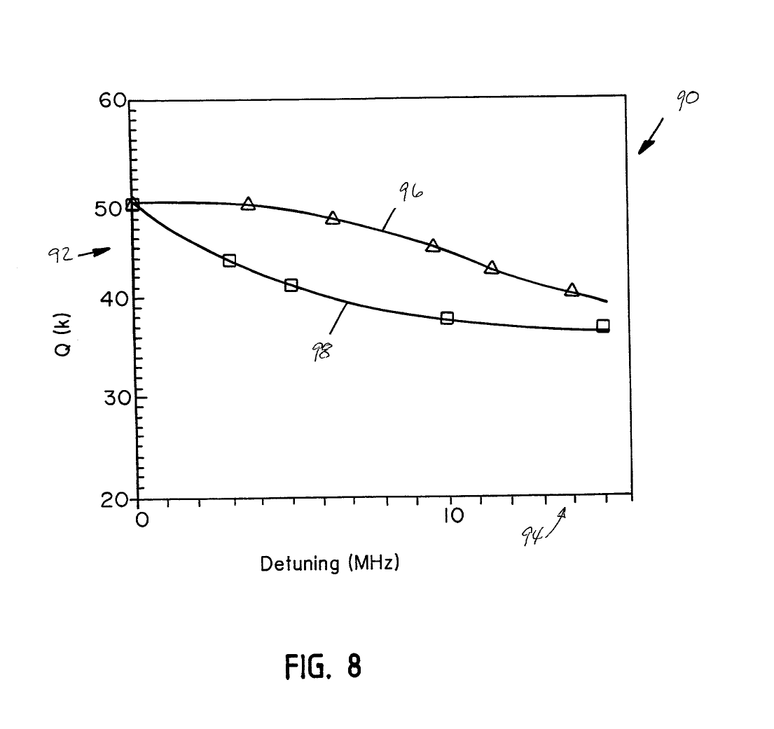

Turning now to FIG. 8, a graph 90 plotting Q, in thousands, on the vertical axis 92 against frequency detuning, in megahertz, on the horizontal axis 94 reveals the comparative performance of a filter using a low loss tuner (represented by plotted line 96) and a conventional silver plated screw tuner (represented by plotted line 98). The data for the graph was obtained by testing a sixteen pole filter having a construction eight times larger than, but similar to, that shown in FIG. 1.

The graph 90 shows that the Q performance of the filter using the low loss tuner 96 is superior to that of a filter using a convention screw tuner 98. The data for the graph 90 was obtained by testing a single resonator of the type shown in FIG. 1. In particular, at 5 MHz detuning, the filter using the low loss tuner has a Q 10,000 higher that the filter using the screw tuner. Even after the Q of the filter using the low loss tuner begins to roll off at about 10 MHz detuning the performance of the filter using the low loss tuner remains superior to the filter using the conventional screw tuner even up to 15 MHz detuning.

It is imcouplerant to realize that the benefits of the low loss tuner extend not only to superconducting filters, but to dielectric resonator filters and air dielectric filters as well. Accordingly, this disclosure should not be interpreted as directed solely to superconducting technology, despite the exemplary superconducting filter disclosed.

As detailed to a certain extent herein, numerous modifications and alternative embodiments of the invention will be apparent to those skilled in the art in view of the foregoing description. This description is to be construed as illustrative only, and is for the purpose of teaching those skilled in the art the best mode of carrying out the invention. The details of the structure and method may be varied substantially without departing from the spirit of the invention, and the exclusive use of all modifications that come within the scope of the appended claims is reserved.

We claim:

1. A tuning mechanism for use in a filter including cavity having a plurality of walls and a resonator disposed within the cavity, the tuning mechanism comprising:
a conductive tuning element adapted to be inserted into the cavity in a location proximate to the resonator, thereby perturbing an electric field of the resonator; and
an electrical insulator mounted to the conductive tuning element and adapted to be adjustably mounted to one of the plurality of walls to hold the conductive tuning element in the location proximate to the resonator.

2. The tuning mechanism of claim 1, wherein the resonator comprises a superconducting resonator.

3. The tuning mechanism of claim 1, wherein the conductive tuning element comprises silver plated stainless steel.

4. The tuning mechanism of claim 3, wherein the conductive tuning element comprises a superconductive coating.

5. The tuning mechanism of claim 1, wherein the conductive tuning element comprises a silver plated nickel alloy.

6. The tuning mechanism of claim 5, wherein the conductive tuning element comprises a superconductive material.

7. The tuning mechanism of claim 1, wherein the conductive tuning element comprises a aluminum.

8. The tuning mechanism of claim 1, wherein the conductive tuning element comprises copper.

9. The tuning mechanism of claim 1, wherein the electrical insulator comprises plastic.

10. The tuning mechanism of claim 1, wherein the electrical insulator comprises Ultem.

11. The tuning mechanism of claim 1, wherein the electrical insulator comprises a dielectric material.

12. A tuning mechanism for use in a filter including cavity having a plurality of walls and a resonator disposed within the cavity, the tuning mechanism comprising:
a conductive tuning element adapted to be inserted into the cavity in a location proximate to the resonator;
an electrical insulator mounted to the conductive tuning element to hold the conductive tuning element in the location proximate to the resonator; and
an adjustment element coupled to the electrical insulator and adapted to be adjustably mounted to one of the plurality of walls to hold the conductive tuning element in the location proximate to the resonator.

13. The tuning mechanism of claim 12, wherein the resonator comprises a superconducting resonator.

14. The tuning mechanism of claim 12, wherein the conductive tuning element comprises silver plated stainless steel.

15. The tuning mechanism of claim 14, wherein the conductive tuning element comprises a superconductive material.

16. The tuning mechanism of claim 12, wherein the conductive tuning element comprises a silver plated nickel alloy.

17. The tuning mechanism of claim 16, wherein the conductive tuning element comprises a superconductive material.

18. The tuning mechanism of claim 12, wherein the electrical insulator comprises a dielectric material.

19. The tuning mechanism of claim 12, wherein the adjustment element is adapted to be threaded into the one of the plurality of walls.

20. The tuning mechanism of claim 12, wherein the adjustment element comprises metallic material.

21. The tuning mechanism of claim 12, wherein the adjustment element comprises brass.

22. A tuning mechanism for use in a superconducting filter including cavity having a plurality of walls and a superconducting resonator disposed within the cavity, the tuning mechanism comprising:
a conductive tuning element having first and second ends and adapted to be inserted into the cavity in a location proximate to the superconducting resonator;
an electrical insulator having first and second ends, wherein the first end of the electrical insulator is threaded into the second end of the conductive tuning element to hold the conductive tuning element in the location proximate to the superconducting resonator; and
a substantially cylindrically shaped adjustment element having first and second ends, wherein the second end of the electrical insulator is threaded into the first end of the adjustment element and the adjustment element is adapted to be threaded into one of the plurality of walls to hold the conductive tuning element in the location proximate to the superconducting resonator.

23. The tuning mechanism of claim 22, wherein the conductive tuning element comprises silver plated stainless steel.

24. The tuning mechanism of claim 23, wherein the conductive tuning element comprises a superconductive material.

25. The tuning mechanism of claim 22, wherein the conductive tuning element comprises a silver plated nickel alloy.

26. The tuning mechanism of claim 25, wherein the conductive tuning element comprises a superconductive material.

27. The tuning mechanism of claim 22, wherein the electrical insulator comprises a dielectric material.

28. The tuning mechanism of claim 22, wherein the adjustment element is adapted to be threaded into the one of the plurality of walls.

29. The tuning mechanism of claim 22, wherein the adjustment element comprises metallic material.

30. The tuning mechanism of claim 22, wherein the adjustment element comprises brass.
